(19) United States
(12) Patent Application Publication
(10) Pub. No.: US 2005/0080165 A1
(43) Pub. Date: Apr. 14, 2005

(54) Composite material containing a polymer and a fine-grained interlocked inert material

(76) Inventor: Lester H. Gabriel, Sacramento, CA (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/957,636

(22) Filed: Oct. 5, 2004

Related U.S. Application Data
(60) Provisional application No. 60/509,273, filed on Oct. 8, 2003.

(51) Int. Cl. C08K 3/34; C08K 7/00

(52) U.S. Cl. 523/220; 524/492

(57) ABSTRACT

A composite material containing a thermoplastic polymer and fine-grained interlocked inert and water-repellent granular material therein, wherein the granular material comprises granular particles approaching intimate contact with surrounding particles thereof, thereby providing an increase in strength and mechanical impedance to creep and plastic flow.

### RELATED APPLICATION

This application is a regular application of and claims priority to provisional application No. 60/509,273, filed on Oct. 8, 2003.

### BACKGROUND OF THE INVENTION

1. Field of the Invention

The present invention relates to a composite material containing a thermoplastic polymer and a fine-grained interlocked inert material therein, the composite material having extraordinary chemical durability and increased strength coupled with heightened mechanical impedance to creep (plastic flow) and reduced vulnerability to stress relaxation.

2. Description of the Background

Portland cement mortar is a material of substantial strength, but suffers from a low threshold of chemical durability when subjected to the corrosive influences of acids that may be found in sanitary sewers, mine wastes and other similar hostile environments. On the other hand, polyethylene is a material of considerable chemical durability, but suffers from serious material creep under sustained structural loads and relaxation of reacting loads and stresses under sustained structural displacements.

It is known to reinforce thermoplastic polymers with fillers in order to enhance various mechanical properties thereof. For example, U.S. Pat. No. 6,444,742 describes polyolefin/sepiolite-polygorskite type clays for producing nanocomposites having improved mechanical properties and thermal resistance. Reinforced thermoplastic compositions have also been prepared in order to provide improved properties at low temperatures. For example, U.S. Pat. No. 5,637,629 describes reinforced polyolefinic thermoplastic compositions containing a polyolefin, aluminum and/or magnesium silicate and a maleamic silane. The purpose of the additives is to improve properties of the reinforced polyolefinic compositions at temperatures lower than 0° C., and particularly as low as −40° C.

In many cases, the desired fillers and polymers are incompatible, requiring the use of either various promoters or additives to achieve compatibility. For example, RE31,992 describes a reinforcement promoter for filled thermoplastic polymers. The reinforcement promoter has at least two reactive olefinic double bonds and a positive promoter index. U.S. Pat. No. 4,873,116A describes a method of preparing mixtures of incompatible hydrocarbon polymers using a compatibilizing system, containing a mineral filler and certain reinforcement additives.

For many applications, however, conventional reinforced thermoplastics provide either inadequate strength, poor impedance to creep (plastic flow) and high levels of stress relaxation. Such properties are especially important in construction materials, such as those used in pipes, manholes, and other structural forms subjected to sustained loads or sustained deformations.

### SUMMARY OF THE INVENTION

Accordingly, it is an object of the present invention to provide a composite material containing a thermoplastic polymer and a fine-grained interlocked inert material therein, which exhibits an increase in strength, mechanical impedance to creep (plastic flow) and diminished stress relaxation.

It is, moreover, an object of the present invention to provide a composite material containing a thermoplastic polymer and a fine-grained interlocked inert material therein, wherein the granular material contains nested and interlocked granular particles approaching complete intimate contact with the surrounding particles thereof, in order to provide an increase in strength, mechanical impedance to creep (plastic flow) and diminished stress relaxation.

It is, moreover, an object of the present invention to provide a composite material, containing a thermoplastic polymer and a fine-grained interlocked, corrosion-resistant, granular material therein, to provide an increase in strength, mechanical impedance to creep (plastic flow) and diminished stress relaxation.

It is, moreover, an object of the present invention to provide a composite material, containing a thermoplastic polymer and a fine-grained interlocked, corrosion-resistant, granular material therein, to provide functionally superior resistance to degradation caused by chemical attack and attack by water.

It is, moreover, an object of the present invention to provide a composite material, containing a thermoplastic polymer and a fine-grained interlocked, corrosion-resistant, water-repelling (hydrophobic) granular material therein, to provide functionally superior resistance to degradation caused by chemical attack and water.

Additionally, it is an object of the present invention that provides a composite material produced by one or more methods for producing the reinforced polymers described above.

### BRIEF DESCRIPTION OF THE DRAWINGS

FIG. 1 illustrates fine-grained interlocked inert material in a thermoplastic polymer.

FIG. 2 illustrates a section of pipe fabricated from the composite material of the present invention.

FIG. 3 illustrates the reduced stress relaxation experienced by the composite material of the present invention.

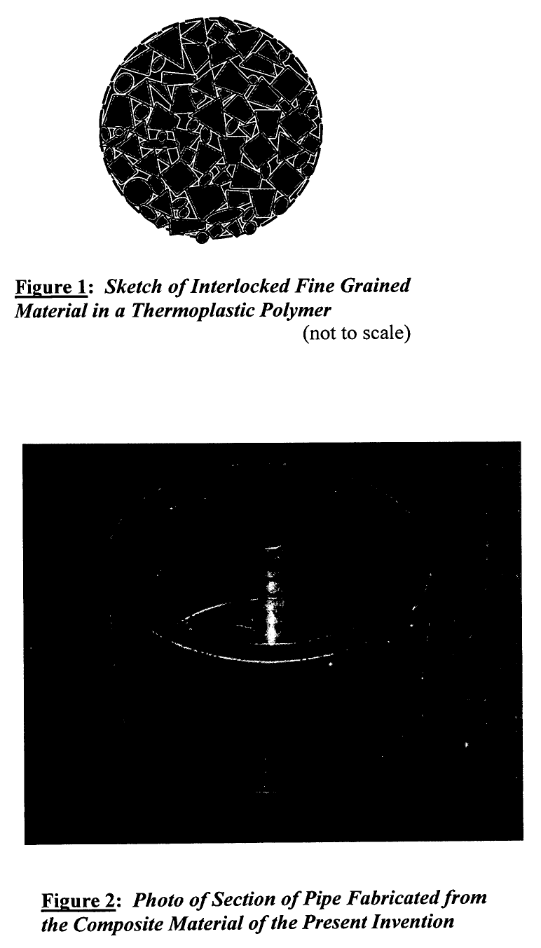

### DETAILED DESCRIPTION OF THE INVENTION

The present invention provides a composite material, containing a polymer and fine-grained interlocked inert material therein, wherein the granular material contains nested granular particles approaching intimate contact with surrounded particles thereof, in order to provide an increase in strength and mechanical impedance to creep (plastic flow) and diminished stress relaxation. Preferably, the fine-grained inert material is: corrosion-resistant, and more particularly, corrosion-resistant to acid attack; water-resistant, and more particularly, resistant to degradation by resisting the attraction of water to the composite material; and is nearly fully interlocked in the composite material to provide an increase in strength and mechanical impedance to creep (plastic flow) and diminished stress relaxation.

Generally, the present composite material utilizes fine-grained particles, such as sand, ground fired clay, quarry dust, fly ash or other natural or manufactured granular material, preferably corrosion resistant, geometrically stabilized by a thermoplastic polymer or co-polymer of processible molecular weight. By “processible molecular weight” is meant a polymer or co-polymer that is processible in the composite material of the present invention. Thereby, a composite material is formulated to achieve a density of granular material in the composite which, as a minimum, approximates its non-mechanically compacted bulk density—the minimum requirement for particles in contact. With sufficient compactive effort, the density of the granular material in the composite can exceed that of the non-mechanically compacted bulk density. Viscosity requirements for processability may limit the amount of granular material. In fact, approaching the limit of particles in contact enhances the likelihood that the granular particles will have the opportunity for intimate contact and interlock with surrounding particles to afford an increase in strength and mechanical impedance to creep, (plastic flow) and diminished stress relaxation.

In more detail, the term “processible molecular weight” means processible by the methodologies described herein, such as centrifugal casting, extension, gravity casting or injection molding, for example.

In accordance with the present invention, any thermoplastic materials, waxes, and resins may be used which are preferably resistant to solvents found in sewer environments. Polyethylene and styrene are examples of such thermoplastic polymers, however, other thermoplastic polymers may be used.

As used herein, the term “thermoplastic” polymer refers to any polymer of material which softens and flows when heated, i.e., sufficiently uncrosslinked. Examples of thermoplastic polymers which may be used in the present invention are: the polyaliphatic type, which include, but are not limited to, polyethylene, polypropylene, polyvinyl chloride (PVC); polyhexamethylene adipamide; the polyarenes type, which include, but are not limited to polystyrene derivatives, polynaphthenic derivatives; and coumarone indene derivatives. However, any thermoplastic polymers may be used. Furthermore, a microcrystalline wax may also be used.

It is particularly preferred to use a polymer characterized by a melt viscosity and molecular weight sufficiently low to enable processing easier than commercially available low-density polyethylene (LDPE), which generally has a molecular weight ranging between 150,000 and 200,000. Such a low molecular weight affords facile processing, at temperatures in the range of 300° F. to 500° F., which is not the case for polyethylene materials of higher molecular weight. Furthermore, by using lower molecular weights as indicated, it is unnecessary, but in many cases desirable, to use vacuum equipment for processing.

Higher molecular weight thermoplastic materials, with vacuum processing are specifically contemplated as useful in the present invention.

As mentioned above, all thermoplastic polymers are considered to be within the scope of the present invention. Thus, in addition to the class of polyaliphatic type, which include, polyethylene, polypropylene, polyvinyl chloride (PVC), other mentionable thermoplastic resins are: polyhexamethylene adipamide; the polyarenes type, which include polystyrene derivatives; polynaphthenic derivatives; and coumarone indene derivatives. Any thermoplastic polymers may be used, including microcrystalline waxes.

Generally, any granular material may be used in accordance with the present invention. It is preferred that the granular material be inert; that is, corrosion-resistant, and more particularly, corrosion-resistant to acid attack. It is also preferred that the granular material be water-repellent, in order to inhibit the transport of water into the composite. Examples of inert granular materials that may be used include sand, ground ceramic materials or quarry dust. Examples of water-repellent granular materials include sands used in the construction of asphalt and asphaltic concrete pavements and quarry dust associated with the manufacture of such sands, and some ground ceramic materials. It is preferred that the inert material be in the form of fine dust-like particles for several reasons. First, the finer the particle size, the more contacts for strength are available in the final product. Second, the more flowable the mix becomes for casting purposes. Third, the final product may be more readily processed, and/or machined.

If desired, however, various other granular materials may be added in order to enhance the aesthetic appearance of the final cast product. For example, any type of colored quartz, such as rose quartz or amethyst may be added. Or any other type of silicate-containing colored mineral such as topaz, zircon, olivine or garnet may be added. Generally, such colored mineral additions, if desired, are added in an amount of up to 20% by weight, and preferably only up to 10% by weight based on the total weight of the mixture.

As used herein, the term “inert” means chemically unreactive. The term “corrosion-resistant” means resistant to corrosive environments, including water. The term “resistant to attack” means resistant to attack by aqueous solutions of inorganic and organic acids, bases, and salts such as ferric chloride. It is particularly preferred that the inert material be resistant to aqueous solutions of sulfuric acid. The term “resistant to attack” means resistant to attack by aqueous, corrosive solutions, including even rusting from water.

As used herein, the term “water-repellent” means rejecting of water (hydrophobic).

As used herein, the term “fine dust-like particles” means fine particles having a grain size distribution such that at least half of the particles are less than about 0.075 mm in diameter.

However, the present invention is not restricted to these particle sizes. For example, while small particle sizes of less-than about 0.100 mm are more favorable for machinability, larger particle sizes may be used where high strength and/or machinability is not of great importance.

Both the inert material and the colored mineral additions, which are both of the same size dimensions, may be ground to a desired size by conventional grinding and sieving methodologies.

The preferred geometry of nested and interlocked granular particles occurs at the conclusion of the cooling process, after contraction of the polymer. The optimum proportions of polymer and granular materials depend upon the specific gravity of each of the components and the qualities and grain size distribution of the granular materials. In the final product the proportions may be, for example, expected to range, by weight, between 40% polymer and 60% granular material to 20% polymer and 80% granular material by weight. However, other ranges may be used and the above ranges are provided only for purposes of illustration.

In accordance with the present invention, the finer of the fine-grained inert granular materials nest within open geometry of the coarser of the fine-grained inert granular materials to form an interlocked network. The polymer serves to maintain the geometry of the interlocked network and to provide toughness to the composite material. This “interlocked network” contributes to both the increased strength and the mechanical impedance to creep (plastic flow) and diminished stress relaxation of the composite. Thus, the term “interlocked network” means a matrix containing larger and smaller particles with the smaller particles nestled between the larger particles.

As noted above, the present thermoplastic composites are resistant to corrosion, preferably to acid attack. It has been observed in testing that a sample of the present thermoplastic composite exhibited no corrosion, as evidenced by the absence of any loss of weight, after immersion for thirteen months in a 10% solution of sulfuric acid, which significantly exceeds the prevalent acid in sanitary sewers. However, the composite material of the present invention is resistant to even greater acidity, such as 20% sulfuric acid, for example.

In the present composite material, each particle is encapsulated in a very thin coating of polymer and is nestled in an array of similar particles with the smaller particles being nested in between the larger ones. The composite array of polymer bound granular particles in close contact inhibits load-induced displacements of individual particles, which in turn provides the geometric stability of the included granular material.

The present composite material further can be manufactured without voids that accompany the hydration of cement in cement mortar and in concrete. In fact, more water than necessary for hydration is added to cement mortar mix for purposes of creating the flowability necessary for proper handling of the cement mortar paste. Upon the consumption of water in the process of hydration of cement and the evaporation of the excess water, voids previously occupied by water occur in the finished cement product. Under service loads, stress concentrations occur at the locations of such voids; the larger the void, the greater the stress concentration. This is avoided with the present composite, as large voids do not occur. Upon cooling there is no evaporation of the polymer. Notably, the present composite material is generally free of voids larger than about 1 mm, and substantially free of voids smaller than about 1 mm. By “substantially free” is meant fewer voids than are found in a Portland cement mortar.

The present composite material may be made by numerous methods including, but not limited to, centrifugal casting, extrusion, gravity casting or injection molding.

All of the processes mentioned are well known. For example, Standard Handbook for Mechanical Engineers, Marks (8^{th} Edition). The present composite material may, for instance, be fabricated into usable portions of tubular castings in a horizontal-spindle machine. The composite material is fed into the mold while spinning. Centrifuigal force permits uniformly thick wall sections to form. Gravity casting as used herein means using the force of gravity, with or without vibration, instead of centrifugal force casting.

Finally, as used herein, the terms “coarser” and “finer” indicate larger and smaller grain sizes in the fine-grained granular material. The term “fine” generally means sand size particles of less than about 4.76 mm (No. 4 sieve) in diameter, preferably less than about 0.075 mm (No. 200 sieve) in diameter. “Coarser” particles generally mean particles larger than 4.76 mm (No. 4 sieve). Neither the “coarser” nor the “finer” particles each need be of uniform size, nor is it preferred that each be of uniform size.

### EXAMPLE

The following is an example of a 6-inch (150 mm) inside diameter, 6-inch long, laboratory model of a section of a manhole (or pipe) that was manufactured employing and embodying the principles of this patent application. The polymer was a polystyrene derivative. The aggregate was hydrophobic granite, 100% passing the No. 200 sieve. The section manufactured was a centrifugal casting with the barrel rotating at 100 revolutions/minute. The mix proportions were 60% aggregate, 40% polymer. Aggregate was introduced at 440° F.±10° F. into the pre-heated 450° F.±10° F. polymer; polymer and sand were kept at 450±10° F. for 15 minutes. The composite was introduced into the rotary mold, which was at 285±10° F. The material was allowed to cool to room temperature before being removed from the barrel. Visual inspection of the section revealed a perfectly formed, smooth (almost glassy) interior and exterior surfaces, free of cracks or other evidences of stress or distortion.

Consider the following experiment, which serves to illustrate the function of granular particles in contact.

A 1 m long, 150 mm (inside) diameter, thick wall steel pipe is positioned vertically and fastened to a base plate. The pipe is loosely filled with granular material and capped with a close fitting surcharge weight. The pipe, granular material and surcharge weight are vibrated; the granular material is compacted and settles (to refusal) within the pipe. In the space vacated by the compacted sand, a close fitting piston is introduced and pressure is placed on the column of compacted sand. The column of compacted sand, restrained by the host steel column from any major alteration of the geometry of the sand's interparticle contact, proves to be a competent structural element.

In contrast, a very thin wall pipe of copper contains a similar column of compacted sand. With increasing pressure the pipe bursts and the sand column collapses and is no longer able to restrain the forces of the piston. The mobilized intergranular shear strength of the particles in contact dissipates as the geometric restraint supplied by the pipe no longer is available. One important function of the polymer is to maintain the geometry of granular particles in contact.

Consider a variable-speed constant radius barrel rotating about its longitudinal axis wherein a pre-prepared, heated and fluid composite of polymer and granular material is introduced within. The more rapid the rotation, the greater the ease with which the composite material adapts to the shape of the barrel. Furthermore, the more rapid the rotation, the greater the centrifugal force that serves to compact and densify the granular material within the composite. Furthermore, the greater the densification of the granular component, the greater proportion of granular material that may be designed as part of the composite. Furthermore, the greater the proportion of granular material in the composite, the greater efficacy of the intergranular contacts and the greater the strength of the cooled composite. Given any particular angular velocity of the rotating barrel, the limit of the amount of granular material that may be included in the composite is reached when the viscosity of the composite material is too great to permit the flow necessary to achieve the desired shape. At this limit, the density of the granular material within the composite may well exceed that of the uncompacted bulk density. Furthermore, the greater the proportion of granular material in the composite, the less costly the composite material.

The conclusion to be drawn is that there is a trade off between the compactive effort employed in the casting process and the amount and density of the granular material within the composite. The greater the compactive effort, the greater the opportunity for a denser, stronger, and more cost efficient end product.

As noted, the term “gravity casting” refers to a process of casting and compaction wherein the force of gravity, with or without vibration and/or surcharge weights and falling weights, is the force of the compactive effort. Generally, a low frequency/high amplitude vibration is preferred to provide a vibration as a gravity assist.

Finally, if desired, casting may be effected in conjunction with positive pressure, as employed in extrusion processes. Thus, extrusion is also another methodology which may be used to prepare the composite material.

In any of the above compaction methods, vacuum induced negative pressure may be employed to further increase the compactive effort.

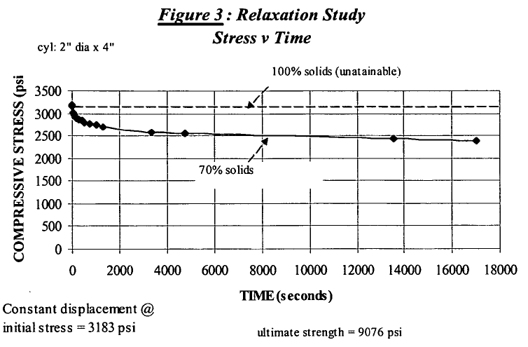

The composite material of the present invention necessarily contains a polymer as described above. Thus, the solids content of fire-grained interlocked material (and colored mineral additive, if used) is necessarily less than 100% of the total weight of the composite material. Further, since a polymer is necessarily included, the composite material is subject to stress relaxation (see FIG. 3), which is common to all plastics. Hence, the term “plastic” may be applied to the present composite material.

Moreover, the stress relaxation shown in FIG. 3 for the present composite material is considerably less than a thermoplastic without granular phase. Hence, the present composite material exhibits a stress relaxation is characterized by a stress relaxation which is less than that exhibited by a thermoplastic polymer not containing a granular material.

Additionally, the present composite material may be manufactured with metal reinforcing that may be in the form of metal bars, metal filler and metal netting, such as expanded metal lathe, hardware cloth or a very closely woven matrix, such as a window screen in a conventional manner.

The present composite material may also be manufactured with other forms of reinforcing, such as plastic fibers and mats, for which nylon and polypropylene may be maintained as examples, in a known manner.

Also, the present composite material may be manufactured to specifications of decreasing stiffness and decreasing brittleness with the introduction of plasticizers to the thermoplastic resins in a conventional manner.

Additionally, the cast material of the present invention is not only machinable, but also sculptable. Thus, the present cast material may be produced in bulk in shapes, such as square or rectangular blocks, which can then be sculpted by artisans and/or technicians by hand or machine to final products of any desired shape or design. Notably, the bulk shapes may be sculpted by hand or machine using conventional hand tools, and machine for sculpting. For example, hammers and chisels may be mentioned as hand tools, while fluting machines may be noted for fabricating fluted columns. These examples are mainly illustrative and are not intended to be limitative.

As used herein, the term “sculptable” means workable by hand or machine to prepare a shaped final product. The present composite material is sculptable, and exhibits a feel and presentation which is like sandstone. The machinability and sculptability of the present cast composite material is due to the fine-grained nature of the material. However, the present cast composite material affords a durability and resistance to erosion which is superior that of sandstone.

Thus, the present cast composite material may be sculpted to various shapes, such as both outdoor and indoor abstract geometric shapes, statuary objects, a birdbath or even building components for outbuildings.

In accordance with another aspect of the present invention, a kit is provided for personal sculpting projects. This kit allows one to sculpt a block of bulk cast composite material to any shaped desired for use as either an indoor or outdoor ornamental object. The kit of the present invention generally includes an unshaped mass or quantity of the cast composite material, and one or more shaping utensils, such as a hummer and chisel. A pedestal for the finished product may also be included as well as general directions for shaping techniques and specific directions for producing sculpted objects of particular shapes and/or designs,

Thus, the present invention composite material may be advantageously used in the preparation of casted decorative or ornamental objects, such as birdbaths, obelisks and statuary for gardens. These various objects may be cast by any of the casting methodologies described above using moulds of an appropriate shape. The statuary may, for example constitute heads alone or entire bodies, particularly classical replicas of Greek and/or Roman origin.

Having described the present invention, it will be apparent that many changes and modification may be made to the above-described embodiments without departing from the spirit and the scope of the present invention.

1. A composite material, comprising a thermoplastic polymer and at least a fine-grained interlocked inert granular material therein, wherein the proportion of the fine-grained granular material, and grain size distribution thereof, is sufficient to enable finer grains to nest within the geometry of coarser grains of said fine-grained granular material, thereby providing an increase in strength, toughness, and mechanical impedance to creep and plastic flow.

2. The composite material of claim 1, wherein said fine-grained inert material is corrosion-resistant.

3. The composite material of claim 2, wherein said inert fine-grained, corrosion-resistant material is resistant to acid attack.

4. The composite material of claim 3, which is resistant to attack by aqueous sulfuric acid.

5. The composite material of claim 1, wherein said fine-grained inert material is water-repellent.

6. The composite material of claim 1, wherein said granular material is arranged such that finer grains nest within the geometry of coarser grains, in said composite material.

7. The composite material of claim 1, wherein said polymer is a poly(aliphatic) thermoplastic polymer.

8. The composite material of claim 1, wherein said polymer is a poly(aromatic) thermoplastic polymer.

9. The composite material of claim 7, wherein said polymer has a molecular weight less than low-density polyethylene.

10. The composite material of claim 8, wherein said polymer has a molecular weight no greater than the molecular weight of the composite material of claim.

11. The composite material of claim 7, wherein said molecular weight is selected for processibility.

12. The composite material of claim 8, wherein said molecular weight is selected for processibility.

13. The composite material of claim 1, wherein said fine-grained inert material has a grain size distribution such that at least 50% are smaller than 4.76 mm (No. 4 sieve).

14. The composite material of claim 2, wherein said inert fine-grained, corrosion-resistant material is resistant to alkaline attack.

15. The composite material claim 4, which is resistant to an aqueous 10% sulfuric acid solution.

16. The composite material of claim 1, wherein proportions of polymer and said fine grained inert granular material may be expected to range, by weight, between about 40% polymer and 60% granular material to 15% polymer and 85% granular material.

17. The composite material of claim 1, wherein said finer grains and said coarser grains are interlocked.

18. The composite material of claim 1, wherein particles of said fine-grained granular material are coated with said thermoplastic polymer.

19. The composite material of claim 1, which is free of voids larger than about 1 mm.

20. The composite material of claim 1, which has a reduced number of voids of less than 1 mm in size relative to Portland Cement.

21. The composite material of claim 1, which is produced by centrifugal casting.

22. The composite material of claim 1, which is produced by gravity casting.

23. The composite material of claim 1, which is produced by injection molding.

24. The composite material of claim 1, which is produced by casting under pressure.

25. The composite material of claim 23, wherein the casting under pressure is extrusion.

26. The composite material of claim 1 which further comprises up to 20% by weight of a colored mineral additive,

27. The composite material of claim 25, wherein said colored mineral additive is present in an amount of up to 10% by weight.

28. The composite material of claim 25, wherein said colored mineral additive is a quarts or other silicate-containing mineral.

29. The composite material of claim 1, which has a stress relaxation less than that of a granular phase.

30. The composite material of claim 1, which is a plastic.

31. The composite material of claim 1, wherein said thermoplastic material contains a plasticizer.

32. A reinforced material, comprising the composite material of claim 1, and metal reinforcement.

33. The reinforced material of claim 1, wherein the metal reinforcement comprises metal bars, metal fiber or metal netting.

34. A reinforced material, comprising the composite material of claim 1, and another plastic.

35. An ornamental object comprising a cast composite material, said composite material being that of claim 1.

36. The ornamental object of claim 34, which is a birdbath.

37. The ornamental object of claim 35, which is a statuary replica.

38. The ornamental object of claim 35, which is sculpted to shape.

39. The ornamental object of claim 38, which is of a geometric shape.

40. A cast material, comprising the composite material of claim 1, which has been cast.

41. A sculptable material in a manufactured, bulk shape, comprising the cast material of claim 40, which is suitable for shaping by hand or machine.

42. A kit, comprising:
a) the sculptable material of claim 41, and
b) one or more shaping utensils for shaping the sculptable material.
